(19) United States
(12) Patent Application Publication
(10) Pub. No.: US 2026/0080852 A1
(43) Pub. Date: Mar. 19, 2026

(54) REAL-TIME AUDIO AUGMENTATION TO USER REQUEST

(71) Applicant: IGT, Las Vegas, NV (US)

(72) Inventors: Soheil LATIFI, Brampton (CA); Stefan KEILWERT, St. Josef (AT); Michael RUSS, Graz (AT)

(73) Assignee: IGT, Las Vegas, NV (US)

(21) Appl. No.: 18/888,053

(22) Filed: Sep. 17, 2024

(51) Int. Cl. G10H 1/00; G06F 3/16

(52) U.S. Cl. CPC G10H 1/0025; G06F 3/167

(57) ABSTRACT

Systems, methods, and servers are provided. A system may include a user interface to receive audio input data from a user input, an audio input device to receive multiple audio signals of multiple audio signal types, a processor circuit and a memory including machine-readable instructions that, when executed by the processor circuit, cause the processor circuit to receive, by an artificial intelligence (AI), the user input and the audio signals that include ones of the audio signal types. The processor is further caused to generate, by a music generator model that receives the user input and the audio signals, output audio content that corresponds with the music generator model, and store the output audio content for subsequent delivery to a user.

### BACKGROUND

The field of disclosure herein is related to providing audio-based gaming experiences.

A casino environment is often noisy and noise-overwhelming as many gaming machine sounds, jackpot sounds, sounds of talking casino visitors, sounds of talking casino staff, casino-wide announcements, casino events/shows, and other sources often generate noise at the same time. Audio experiences in casino machines may be limited to regular stereo and/or surround speakers that may blast game audio substantially straight forward in front of the machine. Additional sensors, such as cameras and/or depth sensors, may be used to locate the position of a player in front of the machine, and use conventional directional sound technologies to try to provide more personal and targeted audio experiences. Additionally, these systems may also fail in providing personalized sound experiences as they may, to some extent, be hearable by other surrounding players. Accordingly, there is a need to provide a technical solution to the technical problem of improving audio-based gaming experience.

### BRIEF SUMMARY

According to some embodiments, systems, methods and devices for providing real-time audio augmentation based on a user request according to some embodiments herein.

Some embodiments include a user interface to receive audio input data from a user input, an audio input device to receive multiple audio signals of multiple audio signal types, a processor circuit, and a memory including machine-readable instructions that, when executed by the processor circuit, cause the processor circuit to perform operations. Operations may include receiving, by an artificial intelligence (AI), the user input and the multiple audio signals that include ones of the audio signal types. Operations further include generating, by a music generator model that receives the user input and the audio signals, output audio content that corresponds with the music generator model. Embodiments include storing the output audio content for subsequent delivery to a user.

According to some embodiments, operations for systems, methods, and devices for facilitating embodiments may be described herein. Methods according to some embodiments include operations of receiving, by an artificial intelligence, a user input and multiple audio signals that include ones of multiple audio signal types. Operations include generating, by a music generator model that receives the user input and the audio signals, output audio content that corresponds with the music generator model. Operations further include storing the output audio content for delivery to a user. Operations may include allowing the user to receive an audio input as an instruction to generate music that corresponds to the music generator model and providing an input for adjusting the output audio content responsive the user earning selected symbols.

According to some embodiments, operations for systems, methods, servers, and devices for facilitating embodiments may be described herein. Embodiments include a schematic block diagram illustrating operations for systems, methods and devices for providing real-time audio augmentation based on a user request according to some embodiments herein. Some embodiments include a server that includes a wireless communication interface that is wirelessly coupled to multiple user audio devices. A processor circuit and a memory are included. The memory includes machine-readable instructions that, when executed by the processor circuit, cause the processor circuit to receive, by an artificial intelligence that includes a large language model to process annotation data of audio input data, a user input and multiple audio signals that include ones of multiple audio signal types. Operations may include generating, by a music generator model that receives the user input and the audio signals, output audio content that corresponds with the music generator model and includes multiple music selections that are annotated based on the plurality of audio signals and storing the output audio content for subsequent delivery to a user. Operations include providing an input for adjusting the output audio content responsive the user performing a game goal and responsive to user earning selected symbols and scanning an audio environment of a casino. Operations further include generating an audible atmosphere profile and sending a message inviting the user to change the output audio content.

Embodiments disclosed herein may provide real-time audio augmentation based on a user request as they would desire to have in a casino environment. Provided are capabilities artificial intelligence to provide real-time audio augmentation.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIGS. 2F and 2G illustrate devices according to various embodiments.

FIGS. 3A-3C, which are schematic block diagrams illustrating view of player audio devices 300 that may be head worn and may have front, top and side views according to some embodiments

FIG. 4 is a schematic block diagram illustrating a system for providing real-time audio augmentation based on a user request in accordance with some embodiments herein.

FIG. 5 is a schematic block diagram illustrating a user interface for providing real-time audio augmentation based on a user request in accordance with some embodiments herein.

FIG. 6 is a schematic block diagram illustrating operations for systems, methods and devices for providing real-time audio augmentation based on a user request according to some embodiments herein.

FIG. 7 is a schematic block diagram illustrating operations for systems, methods and devices for providing real-time audio augmentation based on a user request according to some embodiments herein.

FIG. 8 is a schematic block diagram illustrating operations for systems, methods and devices for providing real-time audio augmentation based on a user request according to some embodiments herein.

### DETAILED DESCRIPTION

As provided herein, disclosures herein may be provided in the context of recent music generation models that use input to generate beat, other percussive audio component that may be used to set an audio rhythm. Some embodiments provide that the player can change the music of the game to their preference, for example if a game has electronic music a player can change such music if they prefer something different. Ins some embodiments, a backend system may be a fusion between a Large Language Model (LLM) and a music generation model. Such module may take user text, interpret the user text and generate the music from it. Some embodiments provide examples of partial changes like, “make it jazzy, add more guitar, take out the electronic ambient elements”. By providing the music that is pleasing to the player, the player happiness may be boosted relative to the playing of annoying songs that may be hard to tolerate.

The vast amount of data received and/or managed by the AI and/or the LLM may limit the access thereof in the absence of a dedicated processor that may be provided in some embodiments. By using the AI, a computer technology may be improved relative to the music provider corresponding to an EGM.

The music of a game may be an artistic element that may be subjectively pleasant. In some embodiments, the goal of music development may have been to satisfy the majority. This strategy usually leaves a handful of users unsatisfied. Such lack of satisfaction may ultimately lead to the player leaving the game based on their preferences. Embodiments provided herein may include modern technology that may help to address an unachievable goal, namely, satisfying everyone.

Embodiments herein may attract customers in multiple different ways. For example, some embodiments attract players due to unmatched novelty, keeping players invested with the new addition to the game, and persuading the players to play with the game since the music is highly adjustable. A player's perspective may include analyzing each step in the process that a player experiences in terms of audio that includes hearable and/or non-hearable audio. For such steps, embodiments may include simply changing background music to “make it jazzy”, among others. Further, considering all sounds, music, effects, etc. in a slot game, such analyzing may begin before the cash in and may end moments after the cash out. In such embodiments, receiving inputs and transmitting outputs in an LLM may provide audio content that may provide previously unrealized complexity and nuance.

Technical implementation provides an LLM creating sounds, saving such created sounds, implementing such sounds into the game and playing the created sounds in a meaningful way. Properties of such sounds may include how the LLM creates the sounds, what the criteria for creating the sounds may include, such as how the sounds are integrated into a game, This might then include things such as how the LLM creates the sounds, where and why such sounds are created. Audio personalization may identify operations for saving and/or restoring sounds to the player and may be incorporated from a technical standpoint.

In some embodiments, the input data for the AI component may include music used in the game along with the transition annotations and/or texts. For example, a transition annotation may include drum music at a jackpot reveal. In some embodiments, a partially trained music generator model may also be utilized. For example, such models may be needed and may add other forms of music that were not produced by an equipment operator, manufacturer and/or owner but might be irrelevant to slot games.

In some embodiment, the music generator model is further trained on a specific set of data, such as data corresponding to a common source. Then the LLM model may be trained on the annotations along with the music. In some embodiments, the goal of the models may be to cooperate to synchronize the annotation and the generated music.

In some embodiments, the output may include pieces of music that are annotated correctly such that the output will be a ready model that can produce music on command.

Some embodiments include a user input interface for easy music adjustment parameters that may be forwarded to the music generation model. In some embodiments, the user input interface may provide an easy operation for the player to feed the music generation model with inputs for making desired adjustments to the model. A user input interface may include multiple input elements including a general music type selection to specify the overall type of music. In some embodiments, the user input interface may include inputs corresponding to multiple music criteria such as base, vocals, and/or speed, among others, that the player may easily adjust by increasing and/or decreasing input values.

Some embodiments include one or more additional input sections in which other inputs may be added and that may describe their music desires. Such inputs may include a plain text input, modular text blocks to select from & build a prompt, a voice input, and/or a music input, such as music sourced from a mobile device.

Some embodiments provide that the user may select a “Generate Music” input causing a prompt to be fed into the music generation model, which may then generate the resulting game music. In the event of the generated game music being unsatisfactory to the player, a “recreate” input may be provided to cause new music to be recreated using the same inputs.

In some embodiments, a player may be required to earn adjustments in a particular game for the user input interface to be available to the player. For example, a player may need to collect one or more specific symbols to unlock specific adjustment options. In some embodiments, the player may be required to fulfill identified game achievements. For example, a player may need to play a given quantity of bonuses to unlock a specific prompt, such as a music prompt, among others.

In some embodiments, different symbols may correspond to specific adjustments to be earned and the player can work towards earned a specific adjustment and/or combination of adjustments thereof. Some embodiments provide that a player may be required to earn adjustments by fulfilling challenges across multiple games. For example, a player may be prompted to play certain games and/or combinations thereof for a given quantity of spins to unlock music prompts for each of the games.

In some embodiments, a gaming device may scan the audio environment in a venue, such as a casino, and may generate music based on the “audio atmosphere” in the venue. In some embodiments, the music generating model may be fed with audio input from the venue using a microphone input and/or other audio component. Some embodiments provide that the music generating model may interpret its “audible atmosphere” and may offer the player the option of determining that they want the device to generate music to support the music atmosphere in the venue by creating game music that is in line with the scanned music. In some embodiments, the player may be distracted with other music types that may override the music from the machine that corresponds to the audio from the venue.

In some embodiments, the player may request that music that is similar to the music being played be selected. In some embodiments, the player may request music that is different from the music being played be selected.

In some embodiments, a player may be given the option to save AI-generated music they like to their “Music Preference” and/or other playlist. Some embodiments provide that the player is able to re-execute this music on any other game. Some embodiments provide that such embodiments may be based on earning new music by playing a given number of games of a new game with default music to qualify for executing their personal playlist.

In some embodiments, upon winning a large award, the player may be provided with a one-time option to change the music. Some embodiments provide that the player be able to change the music immediately and/or may have to wait for another win to change it. In such embodiments, the player may be provided with the option to return to a previous music selection if the player does not like the recent change.

In some embodiments, an EGM may operate as a client to the music generation model. In such embodiments, a central processing circuit may process player inputs and the EGM may act as a client only. In some embodiments, the EGM may offer multiple interfaces to the player to input and configure audio generation. Some embodiments provide topics/words/items that are presented on screen and that may be selected by the player via a touch-screen or other interface type. Some embodiments provide that the input is provided as a voice input and that the EGM may record a player's voice input. In some embodiments, the input may include a text input on the EGM via a virtual keyboard.

In some embodiments, the EGM may include and/or utilize connections to other devices to receive inputs. Such devices may include network devices and/or mobile devices and/or terminals, among others.

In some embodiments, the EGM may perform full processing locally and/or partially processing locally. For example, the EGM may perform translation of voice input into text. Some embodiments provide that connectivity to other devices maybe performed by capturing their input(s) such as wired, wireless and/or optical codes, among others.

In some embodiments, LLMs and other AI technologies may be embedded into the game and processing may be done locally and the outputs may be generated.

In some embodiments, the EGM may capture player input only and then send the information to a central server for further processing. Some embodiments provide that a server processes data and returns results to the EGM for output. In some embodiments, results can be audio configuration settings for the EGM to be used, an audio stream, and/or single audio files, among others. In some embodiments, the central server may be connected to a player tracking system that is operable to remember individual player audio configurations, store audio content and/or settings and restore them for future use.

In some embodiments, an EGM may be equipped with a microphone that can record environmental noise and/or/audio to use it as an additional input for the LLM to improve the audio experience.

In some embodiments, the LLM is aware of current and/or varying noise levels including, for example, noise that depends on the time of the day, and tailors the audio to compensate and/or to create crisp and clear acoustic experience for players. In some embodiments, the LLM may be operable to compensate for deficiencies of speaker/amplifier technology used and. In some embodiments, to improve the audio quality.

Some embodiments provide that, in addition to creating content to support game events, the EGM may also be able to understand a player's voice input to assign LLM created audio content to the game events. Examples of a voice input that may be used to provide audio content include voice commands such as “create a bell sound” or “assign bell sound to near miss effect” or “assign bell sound to any game I play,” among others.

In yet further embodiments, a player may be provided with a dynamic, personalizable audio environment & audio experiences based on the desire of the player in a casino environment. Capabilities described herein may be provided based on capabilities of head-worn audio devices such as headphones, ear pods, and/or personal hearing aid devices among others.

Some embodiments provide a casino audio system that is capable of centrally managing multiple audio devices to provide dynamic audio system and/or dynamic, casino-specific Active Noise Cancellation (ANC). According to embodiments herein, the ANC may be used to provide personalizable audio experiences. Such audio experiences may be provided based on underlying operator-provided master controls.

Embodiments herein may include a casino-wide audio system that can connect with audio devices on the casino floor. For example, different sound origins may include game background music, jackpot jingle, and/or bingo-based casino announcements, among others, that are based on player preferences.

In some embodiments, an ANC component may allow the player to adjust several sound origins and/or audio channels respective to ANC by letting the player personalize their casino-specific ANC profile. The ANC component may provide the player with their desired audio environment and/or audio experiences for their casino visit.

According to some embodiments a casino system may connect multiple systems, devices and/or casino-specific components. In this manner, a casino system may provide an audio experience that is dynamic. The casino system may include and/or be connected to a casino-wide audio system that may enable connection of audio devices on the casino floor. In some embodiments, the audio system may limit the number of connected devices per access point. In such embodiments, tethering and/or multiple access point setups may be included. In some embodiments, each gaming device may provide such an access point.

Some embodiments include creating anti-noise signals to cancel unwanted noise out and/or to provide player with “clean” audio. A casino-specific ANC component may be dynamic and thus may be responsive to conditions and/or activities in the casino. Some embodiments provide that the ANC component is provided in real time and/or may be area specific. In some embodiments, the ANC component may be casino-specific and may automatically and selectively exclude people's voices. For example, the ANC component may only route through noises from other games on the floor so the user may not hear people, but may still hear other sounds contributed by other aspects of the full casino environment. In some embodiments, the ANC component may be trained using sound and/or voice recognition training to create a profile of known, repeated casino-specific sounds.

In some embodiments, reference microphones may be provided to enable ANC to monitor ambient sounds/noises. For example, a headphone integrated microphone and/or an EGM-integrated microphone may be connected to a mobile device's microphone.

In some embodiments, an audio personalization system that may be provided to the player may be used for both the sound routing component and the ANC component.

Include a player's mobile device that may be connected to head-worn audio device, the casino announcement system, and/or a gaming machine, among others.

Some embodiments provide that ANC logic may be integrated into a head-worn audio device.

Some embodiments provide that one or more casino environment sounds may include casino staff voice, other visitor voice, event/show performers voice, event/show sounds, electronic table game sounds, noise from other areas (e.g., restaurant sounds), voice of people approaching, animal sounds, and/or phone calls, sounds and voices, among others.

Some embodiments include an ANC-system that is specific to a casino environment. An ANC system may store casino-specific noises and may differentiate between each of the different sound sources including game sounds, people talking, and/or jackpot sounds, among others.

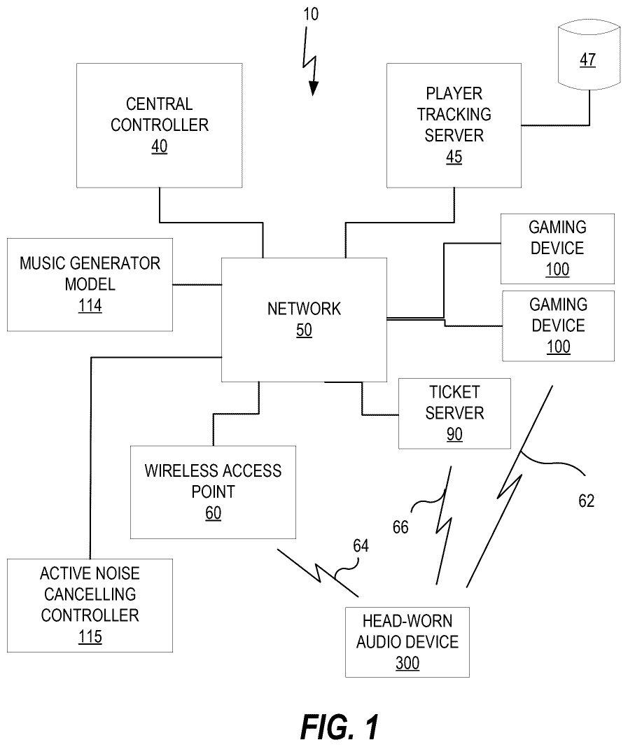

Before discussing these and other embodiments in greater detail, reference will be made to an example of a gaming system for implementing embodiments disclosed herein. In this regard, FIG. 1 illustrates a gaming system 10 including a plurality of gaming devices 100 is illustrated. As discussed above, the gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

The wireless interfaces 62, 66 allow a plurality of head worn audio devices 300 to coordinate the generation and rendering location based enhanced audio features to the player. In some embodiments, the gaming system 10 includes a music generator model 310. The music generator module 310 may communicate through the data communication network 50 with the EGMs 100 and the head worn audio devices 300 to provide real time audio augmentation. Some embodiments may coordinate the generation and transmission of enhanced audio experiences to one or more players using the head worn audio devices 300. The music generator model 310 may be implemented within or separately from the central controller 40.

In some embodiments, the music generator module 310 may coordinate the generation and/or transmission of the enhanced audio features and/or experiences.

Moreover, in some embodiments, the music generator module 302 may coordinate the generation and transmission of audio features to players at different physical locations, as will be described in more detail below.

The music generator module 310 may enable sound to be routed to one or more specific head worn audio devices 300 quickly and accurately and also may enable the head worn audio device 300 while using the head worn audio device 300.

In some embodiments, at least some processing of enhanced audio that is rendered by the head worn audio device 300 may be performed by the music generator model 302, thereby offloading at least some processing requirements from the head worn audio devices 300.

Some embodiments may include an active noise cancelling (ANC) controller 115 that may provide ANC based on inputs casino-specific inputs. For example, an ANC component may be personalized and, in combination with the casino-specific sound routing, may provide personalized dynamic sound controlled by a casino system.

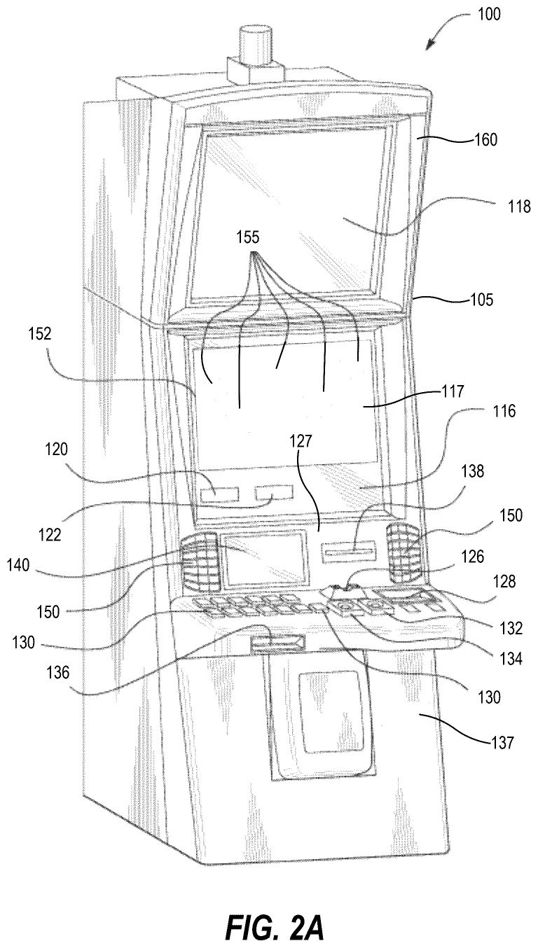

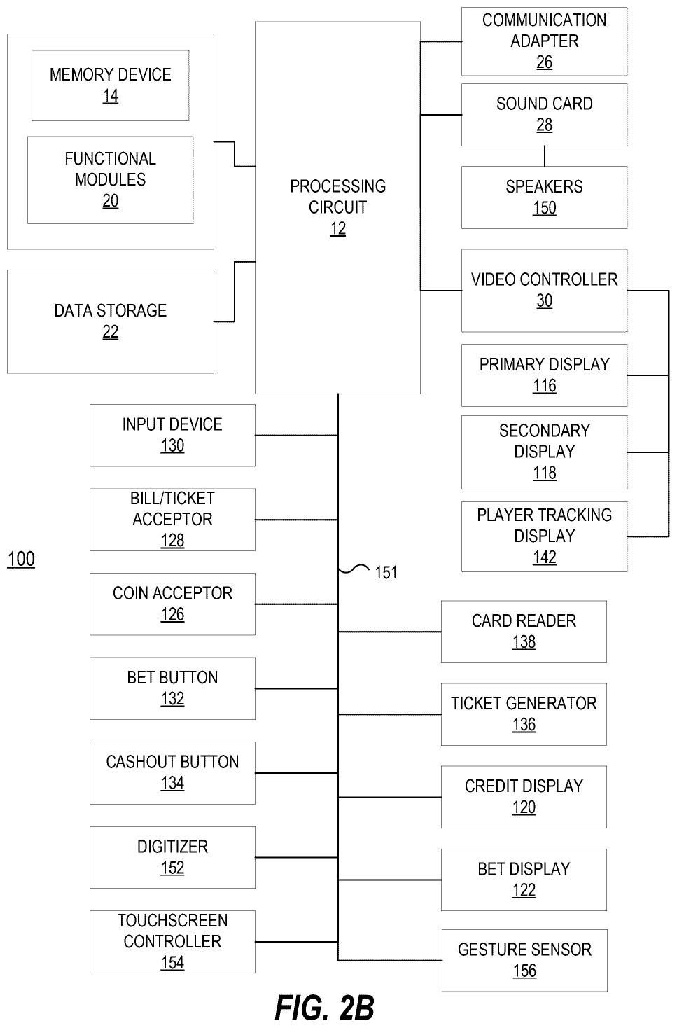

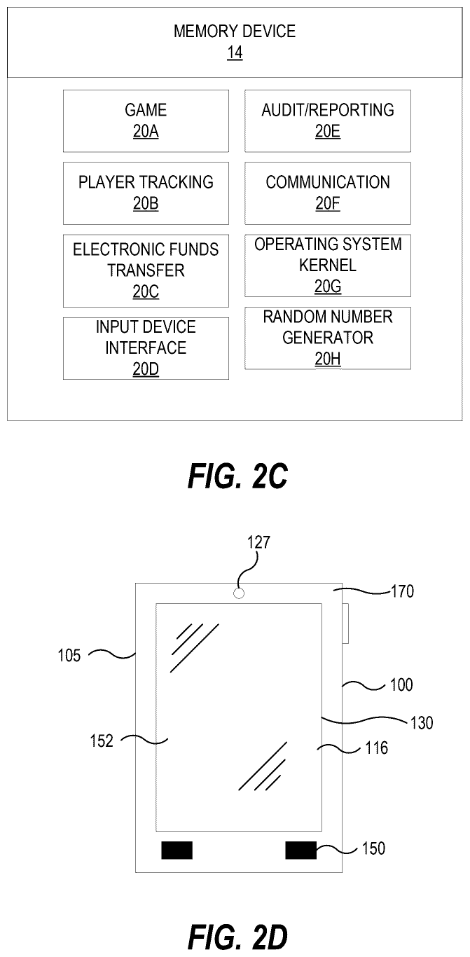

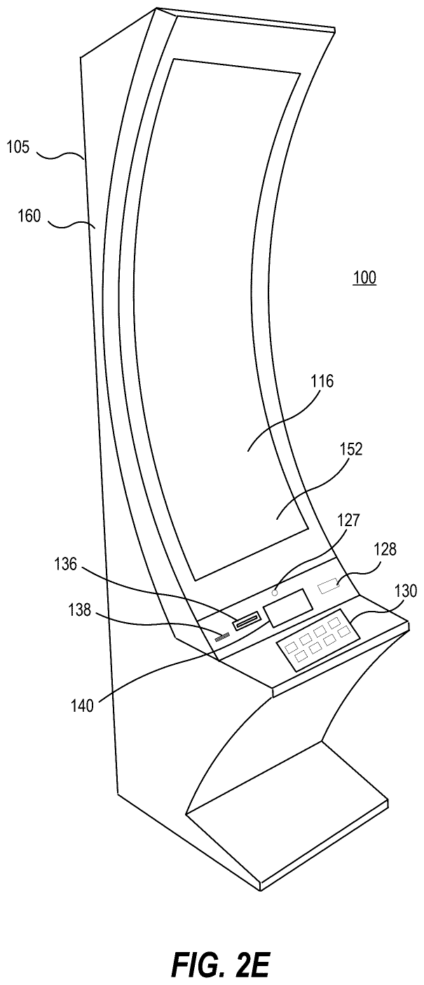

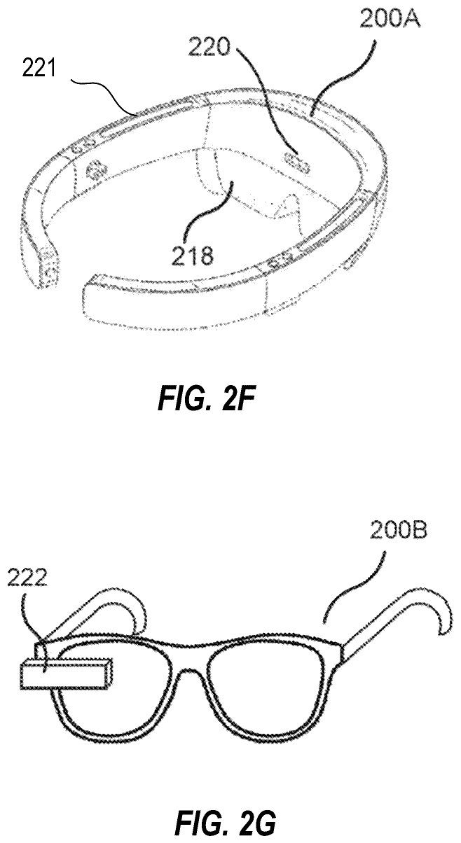

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player. The communication adapter 26 may communicate with other devices using a wireless communication protocol that includes location and/or position data to the other devices.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processor circuit through a USB hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

FIG. 2F illustrates an augmented reality viewer 200A implemented as a 3D headset including a pair of displays 218 on which images of virtual objects may be displayed. The augmented reality viewer 200A includes a head-wearable frame 222, with the displays 218 coupled to the frame 221 to position the display device in a field of view of user wearing the augmented reality viewer 200A. Different stereoscopic images may be displayed on the displays 218 to create an appearance of depth. The augmented reality viewer 200A may include a plurality of sensors 220 that the device uses to determine a position, orientation, and/or movement of the augmented reality viewer 200A, which may be used to determine a position, orientation, and/or direction of movement within an SVE.

The augmented reality viewer 200A may further include other sensors, such as a gyroscopic sensor, a GPS sensor, one or more accelerometers, and/or other sensors that allow the augmented reality viewer 200A to determine its position and orientation in space. In some embodiments, the augmented reality viewer 200A may include one or more cameras that allow the viewer 200A to determine its position and/or orientation in space using visual simultaneous localization and mapping (VSLAM). The augmented reality viewer 200A may further include one or more microphones and/or speakers that allow the user to interact audially with the device.

In some embodiments, a viewer may also include semitransparent lenses that allow the user to see both the real world as well as the 3D image rendered on the lenses, e.g., to provide an augmented reality (AR) experience. The viewer may also include additional cameras or other sensors to obtain a live video signal for building a 3D model of the space around the user. The viewer may also generate a 3D image of an object to display to the user that takes into account the real world objects around the user and allows the user to interact with the 3D object.

Referring to FIG. 2G, an augmented reality viewer 200B may be implemented as a pair of glasses including a transparent prismatic display 222 that displays an image to a single eye of the user. Such a device may be capable of displaying images to the user while allowing the user to see the world around the user, and as such can be used as an AR device.

In other embodiments, a VR and/or AR viewer may be implemented using a virtual retinal display device that raster scans an image directly onto the retina of the user. In still further embodiments, a VR and/or AR viewer may be implemented using a mobile wireless device, such as the mobile gaming device 170 of FIG. 2D above, a mobile telephone, a tablet computing device, and/or a personal digital assistant, etc.

Although illustrated as certain gaming devices, such as electronic gaming machines (EGMs), mobile gaming devices, VR/AR headsets, head worn audio devices, etc., functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

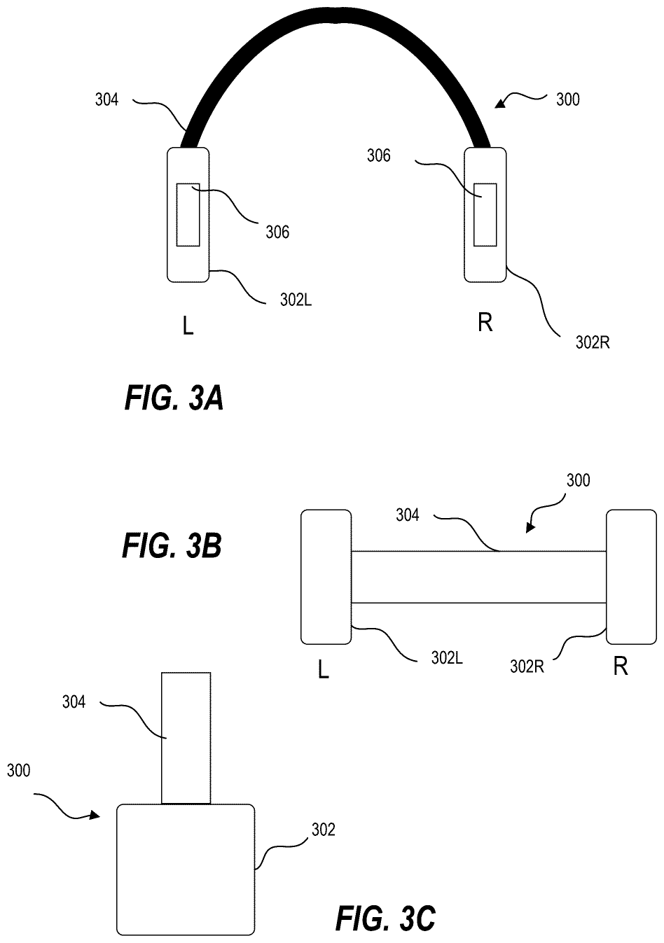

Reference is now made to FIGS. 3A-3C, which are schematic block diagrams illustrating view of player audio devices 300 that may be head worn and may have front, top and side views according to some embodiments. Referring to FIGS. 3A-3C, left and right speakers 302 may be mechanically coupled to one another via a head-band 304. In some embodiments, the left and right speakers 302L, 302R may be communicatively coupled to one another. For example, the right and left speakers 302L, 302R may be wirelessly coupled with one another. In some embodiments, the left and right speakers 302L, 302R may be conductively coupled to one another via a wire and/or an electronic circuit.

One or each of the speakers 302 may include communication interfaces 306 that provide communication between the speakers 302 and/or external objects and/or systems.

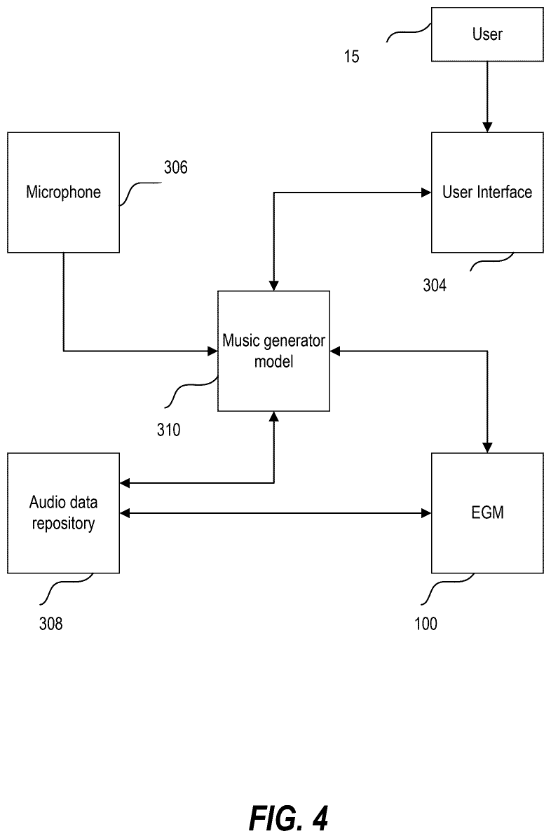

Brief reference is now made to FIG. 4, which is a schematic block diagram illustrating a system for providing real-time audio augmentation based on a user request in accordance with some embodiments herein. As provided herein, a music generator model 310 may generate output audio content based on user inputs that may be received via a user interface 304.

In some embodiments, the music generator model 310 may receive further inputs from other system components. For example, the music generator model 310 may receive input data from an EGM 100 that may be used to generate the output audio content. In some embodiments, the music generator model 310 may receive input data from a microphone 306 that may provide audio input content corresponding to ambient sounds/noise. Some embodiments include an audio data repository 308 that may store audio signals and/or portions and/or fractions thereof. In some embodiments, the audio data repository 308 may receive and/or provide audio content with the music generator model 310 and/or the EGM 100.

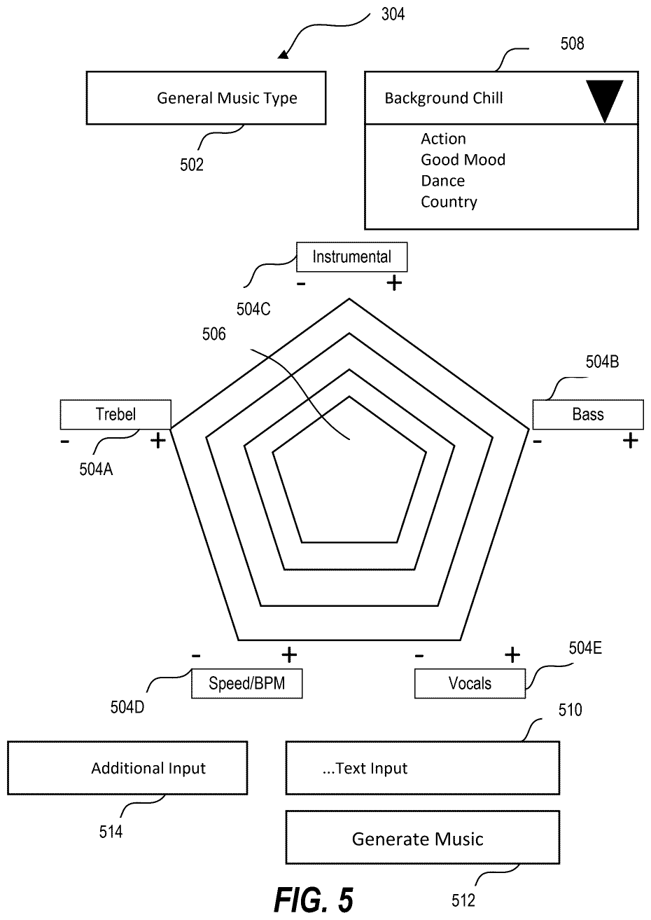

Brief reference is now made to FIG. 5, which is a schematic block diagram illustrating a user interface for providing real-time audio augmentation based on a user request in accordance with some embodiments herein. As illustrated, the user interface 304 may include a general music type input 502 that may receive text and/or voice audio of inputs for receiving such data into the music generator model 310. In some embodiments, a pull-down menu 508 may identify suggested and/or previously selected general music type. For example, the illustrated menu may include general music types of “Background Chill”, “Action”, “Good Mood”, “Dance”, and/or “Country”, among others.

Some embodiments provide that other music property inputs 504 may be provided as different music properties that may adjusted to affect the output audio content. Non-limiting examples of such music property inputs include treble bandwidth level 504A, bass bandwidth level 504B, instrumental portion 504C, speed/beats per minute 504D, and/or vocal portion 504E, among others. In some embodiments, the music property inputs may be controlled by using an input that receives and increase and/or a decrease input.

Some embodiments provide an “additional input” 514 for receiving other types of audio inputs. Further, a text input 510 is provided for receiving text input data. Once selections and/or new input data is received, the user may engage the generate music input 512 to cause the newly generated and/or altered output audio content to be provided.

Some embodiments provide that the user interface 304 may be a graphical user interface 506 that is operable to provide display portions. The display portions may be icons that are displayed based on absolute and/or relative values of the music property inputs. For example, icons corresponding to music property inputs 504 may be arranged on the display portion corresponding to the value of those music property inputs.

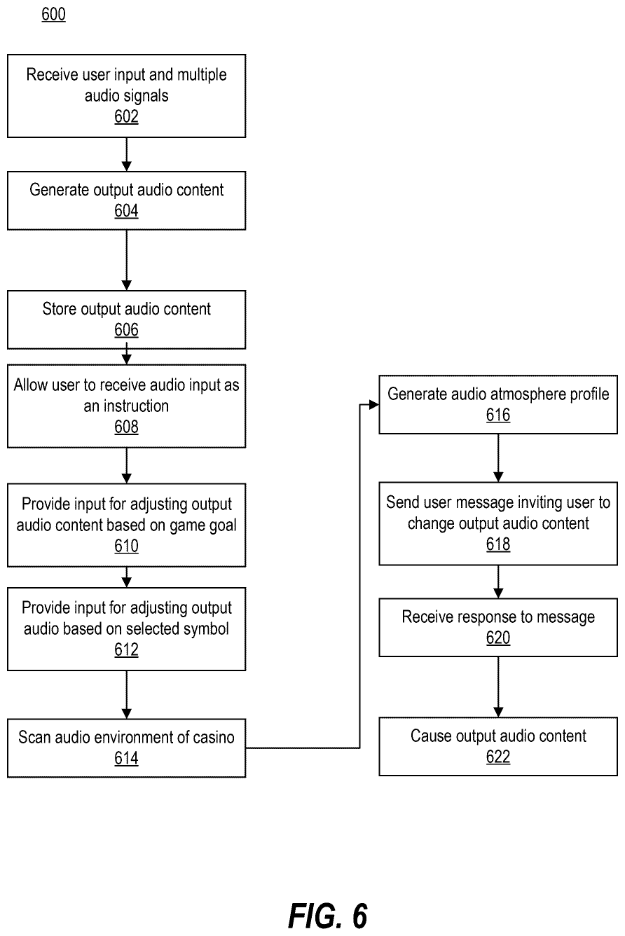

Reference is now made to FIG. 6, which is a schematic block diagram illustrating operations for systems, methods and devices for providing real-time audio augmentation based on a user request according to some embodiments herein. Some embodiments include a user interface to receive audio input data from a user input, an audio input device to receive multiple audio signals of multiple audio signal types, a processor circuit, and a memory including machine-readable instructions that, when executed by the processor circuit, cause the processor circuit to perform operations. Operations may include receiving (block 602), by an artificial intelligence (AI), the user input and the multiple audio signals that include ones of the audio signal types.

The term AI, as used herein, may refer to multiple different may include processes, software and/or hardware that provides the general ability of specialized and/or general purpose computers to emulate human thought and/or portions thereof. AI systems may include one or more of a large language model, machine learning, deep learning, neural networks, computer vision and/or natural language processing, among others. AI may include associative memory, Artificial Narrow Intelligence (ANI), Artificial General Intelligence (AGI), and/or Artificial Super Intelligence (ASI), among others. AI may further include reactive machines, limited memory, theory of mind, and/or self-aware, among others.

Operations further include generating (block 604), by a music generator model that receives the user input and the audio signals, output audio content that corresponds with the music generator model. Embodiments include storing (block 606) the output audio content for subsequent delivery to a user.

In some embodiments, ones of the audio signal types include inaudible audio content that is transmitted in a frequency range that is not detected in a human auditory range.

Some embodiments provide that the audio signal types include voice inputs that include a player's voice received via the user interface and that are used to generate the output audio content. In some embodiments, ones of the audio signal types include music from an electronic gaming machine (EGM) that the user is playing and may be used to generate the output audio content. In some embodiments, ones of the audio signal types may include sound effects that correspond to ambient sounds in a casino environment. Some embodiments provide that the sound effects are and used to generate the output audio content.

In some embodiments, the audio input data includes audio game content corresponding to an electronic gaming machine (EGM) that the user is playing. In some embodiments, the audio input data includes modified audio game content based on additional inputs to the music generator model.

In some embodiments, the user interface includes multiple inputs that are caused to be displayed to the user via the user interface to change an input value corresponding to one of multiple audio properties selected by the user. In some embodiments, the user interface includes inputs that comprise a general music type that corresponds to a music type that is selected by the user. Some embodiments provide that a user input includes inputs that include modular text blocks to select and build a prompt to generate audio content.

In some embodiments, the AI includes a large language model to process annotation data of audio input data.

Some embodiments provide that the processor circuit is further caused to allow (block 608) the user to receive an audio input as an instruction to generate music that corresponds to the music generator model.

In some embodiments, the output audio content includes multiple music selections that are annotated based on the audio signals.

In some embodiments, the processor circuit is further caused provide (block 610) an input for adjusting the output audio content responsive the user performing a game goal.

Some embodiments provide that the processor circuit is further caused provide (block 612) an input for adjusting the output audio content responsive the user earning selected symbols.

In some embodiments, the processor circuit is further caused to scan (block 614) an audio environment of a casino, generate (block 616) an audible atmosphere profile, send (block 618) a message inviting the user to change the output audio content, receive (block 620) a response to the message, and cause (block 622) an output audio content change in response to receiving the response.

Some embodiments provide that processing the audio signals is performed for multiple EGMs by a central player input process that is remote from the processing circuit and that receives data from the plurality of EGMs.

In some embodiments, ones of the audio signal types include voice inputs that include a player's voice received via the user interface and used to generate the output audio content. Some embodiments provide that the voice inputs are further caused to use voice recognition to identify the user.

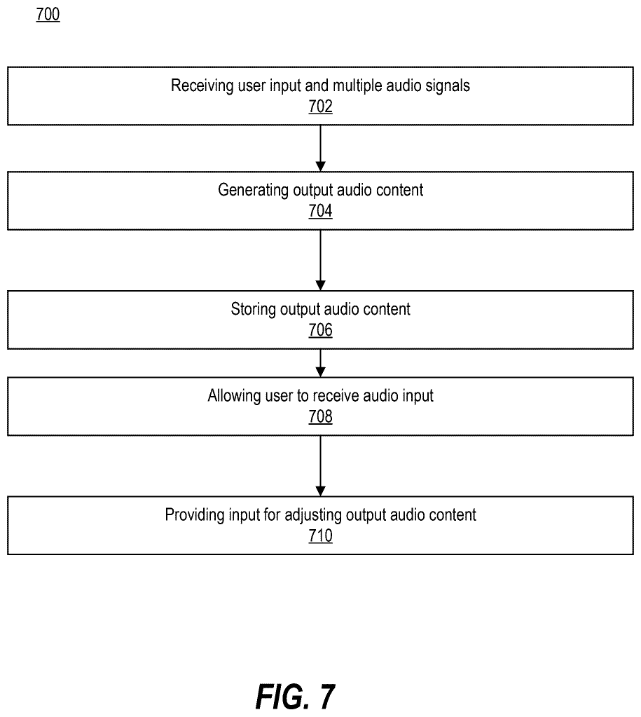

Reference is now made to FIG. 7, which is a schematic block diagram illustrating operations for systems, methods and devices for providing real-time audio augmentation based on a user request according to some embodiments herein. Operations may include receiving (block 702), by an artificial intelligence, a user input and multiple audio signals that include ones of multiple audio signal types. Operations include generating (block 704), by a music generator model that receives the user input and the audio signals, output audio content that corresponds with the music generator model. Operations further include storing (block 706) the output audio content for delivery to a user. Operations may include allowing (block 708) the user to receive an audio input as an instruction to generate music that corresponds to the music generator model and providing (block 710) an input for adjusting the output audio content responsive the user earning selected symbols.

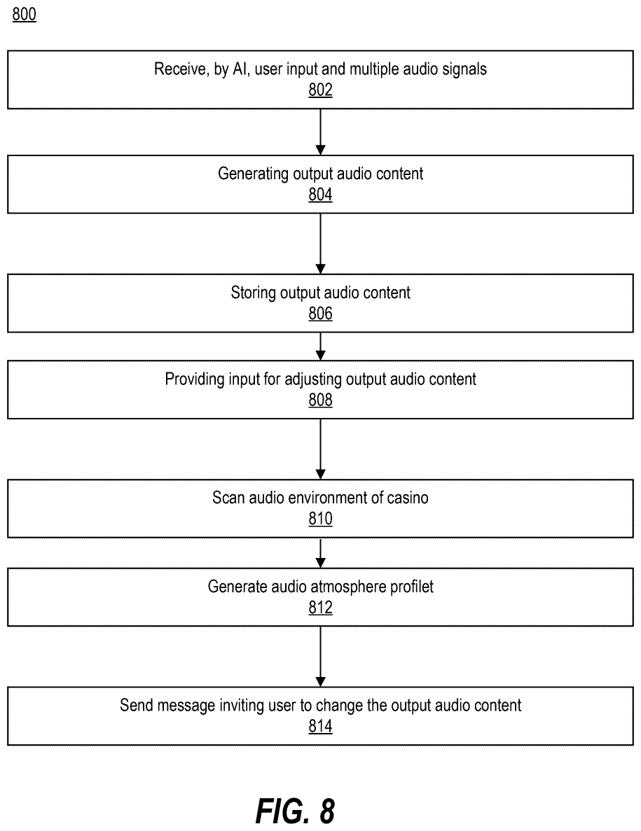

Reference is now made to FIG. 8, which is a schematic block diagram illustrating operations for systems, methods and devices for providing real-time audio augmentation based on a user request according to some embodiments herein. Some embodiments include a server that includes a wireless communication interface that is wirelessly coupled to multiple user audio devices. A processor circuit and a memory are included. The memory includes machine-readable instructions that, when executed by the processor circuit, cause the processor circuit to receive (block 802), by an artificial intelligence that includes a large language model to process annotation data of audio input data, a user input and multiple audio signals that include ones of multiple audio signal types. Operations may include generating (block 804), by a music generator model that receives the user input and the audio signals, output audio content that corresponds with the music generator model and includes multiple music selections that are annotated based on the plurality of audio signals and storing (block 806) the output audio content for subsequent delivery to a user. Operations include providing (block 808) an input for adjusting the output audio content responsive the user performing a game goal and responsive to user earning selected symbols and scanning (block 810) an audio environment of a casino. Operations further include generating (block 812) an audible atmosphere profile and send (block 814) a message inviting the user to change the output audio content.

Embodiments described herein may be implemented in various configurations for gaming devices, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor circuit of a general purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a user interface to receive audio input data from a user input;
an audio input device to receive a plurality of audio signals of a plurality of audio signal types;
a processor circuit; and
a memory comprising machine-readable instructions that, when executed by the processor circuit, cause the processor circuit to:
receive, by an artificial intelligence (AI), the user input and the plurality of audio signals that comprise ones of the plurality of the audio signal types;
generate, by a music generator model that receives the user input and the plurality of audio signals, output audio content that corresponds with the music generator model; and
store the output audio content for subsequent delivery to a user.

2. The system of claim 1, wherein ones of the audio signal types comprise inaudible audio content that is transmitted in a frequency range not detected in a human auditory range.

3. The system of claim 1, wherein ones of the audio signal types comprise voice inputs that comprise a player's voice received via the user interface and used to generate the output audio content.

4. The system of claim 1, wherein ones of the audio signal types comprise music from an electronic gaming machine (EGM) that the user is playing and used to generate the output audio content.

5. The system of claim 1, wherein ones of the audio signal types comprise sound effects that correspond to ambient sounds in a casino environment and used to generate the output audio content.

6. The system of claim 1, wherein the audio input data comprises audio game content corresponding to an electronic gaming machine (EGM) that the user is playing.

7. The system of claim 1, wherein the audio input data comprises modified audio game content based on additional inputs to the music generator model.

8. The system of claim 1, wherein the user interface comprises a plurality of inputs that are caused to be displayed to the user via the user interface to change an input value corresponding to one of a plurality of audio properties selected by the user.

9. The system of claim 1, wherein the user interface comprises inputs that comprise a general music type that corresponds to a music type that is selected by the user.

10. The system of claim 1, wherein a user input comprises inputs that comprise modular text blocks to select and build a prompt to generate audio content.

11. The system of claim 1, wherein the AI comprises a large language model to process annotation data of audio input data.

12. The system of claim 1, wherein, the processor circuit is further caused to allow the user to receive an audio input as an instruction to generate music that corresponds to the music generator model.

13. The system of claim 1, wherein the output audio content comprises a plurality of music selections that are annotated based on the plurality of audio signals.

14. The system of claim 1, wherein the processor circuit is further caused provide an input for adjusting the output audio content responsive the user performing a game goal.

15. The system of claim 1, wherein the processor circuit is further caused provide an input for adjusting the output audio content responsive the user earning selected symbols.

16. The system of claim 1, wherein the processor circuit is further caused to: scan an audio environment of a casino;
generate an audible atmosphere profile;
send a message inviting the user to change the output audio content;
receive a response to the message; and
cause an output audio content change in response to receiving the response.

17. The system of claim 1, wherein processing of the plurality of audio signals is performed for a plurality of EGMs by a central player input process that is remote from the processing circuit and that receives data from the plurality of EGMs.

18. The system of claim 1, wherein ones of the audio signal types comprise voice inputs that comprise a player's voice received via the user interface and used to generate the output audio content, and wherein the voice inputs are further caused to use voice recognition to identify the user.

19. A method comprising:
receiving, by an artificial intelligence, a user input and plurality of audio signals that comprise ones of a plurality of audio signal types;
generating, by a music generator model that receives the user input and the plurality of audio signals, output audio content that corresponds with the music generator model;
storing the output audio content for delivery to a user;
allowing the user to receive an audio input as an instruction to generate music that corresponds to the music generator model; and
providing an input for adjusting the output audio content responsive the user earning selected symbols.

20. A server comprising:
a wireless communication interface that is wirelessly coupled to a plurality of user audio devices;
a processor circuit; and
a memory comprising machine-readable instructions that, when executed by the processor circuit, cause the processor circuit to:
receive, by an artificial intelligence that comprises a large language model to process annotation data of audio input data, a user input and a plurality of audio signals that comprise ones of a plurality of audio signal types;
generate, by a music generator model that receives the user input and the plurality of audio signals, output audio content that corresponds with the music generator model and comprises a plurality of music selections that are annotated based on the plurality of audio signals;
store the output audio content for subsequent delivery to a user;
provide an input for adjusting the output audio content responsive the user performing a game goal and responsive to user earning selected symbols; and
to scan an audio environment of a casino;
generate an audible atmosphere profile; and
send a message inviting the user to change the output audio content.
